(19) United States
(12) Patent Application Publication
(10) Pub. No.: US 2013/0104119 A1
(43) Pub. Date: Apr. 25, 2013

(54) STREAMING PACKETIZED BINARY PATCHING SYSTEM AND METHOD

(71) Applicants: Brian Matsuo, Los Altos, CA (US); Wilson Yeung, San Mateo, CA (US)

(72) Inventors: Brian Matsuo, Los Altos, CA (US); Wilson Yeung, San Mateo, CA (US)

(21) Appl. No.: 13/279,866

(22) Filed: Oct. 24, 2011

(51) Int. Cl. G06F 9/44

(52) U.S. Cl. 717/173

(57) ABSTRACT

A computer-implemented system and method for updating an electronic device. One method includes obtaining a binary patch for a binary image being executed by the device, generating a plurality of independent packets based on the binary patch to be applied by the device to the binary image to generate a portion of a patched binary image, wherein the packets are streamed to the device over at least one network. An electronic device executing a binary image is also provided, which includes an input/output interface configured to receive a stream of independent binary patch packets from at least one server that are generated by the server based on a binary patch, and a processor configured to apply each packet to the binary image to generate a portion of a patched binary image and, when the processor has applied each of the packet, replace the binary image with the patched binary image.

### BACKGROUND

Electronic devices often need software updates to correct bugs or to change or add device functionality. However, such devices are often distributed throughout a geographic region, which makes direct updating virtually impossible given time and resource constraints. For example, large numbers of electricity or other utility meters are distributed throughout many geographic regions and updating these devices directly (e.g., physically visiting each device and directly loading new software into the device) would be expensive and time-consuming. As other examples, other devices, such as cellular phones, personal computers, etc., can also be widely distributed, which makes direct updates impractical.

To overcome the issues associated with direct updates, if an electronic device is connected to a network (e.g., a local area network (“LAN”), a wide area network (“WAN”), a priority network, the Internet, and the like), an update can be transmitted to the electronic device over the network. However, there are numerous problems with using network-based updates. First, the device receiving the update must have a reliable connection to the network. If a device loses its connection to the network before receiving an entire update and tries to install an incomplete update, the device may not be properly updated and may malfunction. Similarly, if an update is large, it may take a long time for the device to receive the entire update, which can increase bandwidth requirements. In addition, if the device is battery-powered, the device may be required to be “turned on” during the entire updating process, which reduces the device's battery life. Also, until the entire update is received by the device, the device generally must continue to perform using current software. Therefore, devices generally must have sufficient memory to store current software and at least temporarily store any received updates. If the update is large, the memory requirements for the device may be increased, which increases the cost of the device.

Binary patching has been used to provide updates to electronic devices. In the binary patching process, a delta file is typically generated, and includes the differences between an original binary file and an updated binary file. The delta file can then be compressed into what is known as a patch, and the patch can be transmitted to a device. The device applies the patch to the original binary file stored in the device to generate the updated binary file. The device can then switch from executing the original binary file to the updated binary file. In some embodiments, the patch is smaller than both the original binary file and the updated binary file, which reduces update times and bandwidth requirements. However, binary patching generally requires that a device receive and store an entire patch before applying the patch. Therefore, the device must include adequate memory for storing an entire patch, which may vary in size depending on the degree of the update (i.e., the amount of difference between the original software and the updated software).

Based at least in part upon these and other limitations of existing software patching systems and methods, new software patching systems and methods are welcome additions to the art.

### SUMMARY

Some embodiments of the present invention provide methods, systems, and non-transitory computer-readable medium containing instructions for updating an electronic device using streaming packetized binary patching. Packetized streaming binary patching does not require the storage of the entire binary patch on the target device. Therefore, the device does not require additional memory allocations for storing an entire binary patch. In addition, by using packetized streaming binary patching, device updates can be performed using fewer resources, such as time, network bandwidth, and the device's battery life. Therefore, updates can be performed quickly and efficiently

In some embodiments, a computer-implemented method for updating an electronic device is provided, and comprises obtaining a binary patch for a binary image currently being executed by the electronic device; generating a plurality of packets based on the binary patch, wherein each packet is independent such that each packet can be applied by the electronic device to the binary image independent of applying the other packets to generate a portion of a patched binary image; and streaming each of the plurality of packets to the electronic device over at least one network.

Some embodiments of the present invention provide a system for updating an electronic device, wherein the system comprises a server configured to obtain a binary patch for a binary image currently being executed by the electronic device, to generate a plurality of packets based on the binary patch, wherein each packet is independent such that each packet can be applied by the electronic device to generate a portion of a patched binary image independent of applying the other packets, and to stream each of the plurality of packets to the electronic device over at least one network.

In some embodiments of the present invention, an electronic device configured to execute a binary image is provided, and comprises a processor and an input/output interface. The input/output interface is configured to receive a stream of a plurality of binary patch packets from at least one server, each of the plurality of binary patch packets being generated by the server based on a binary patch and being independent such that each packet can be applied by the electronic device to the binary image independent of the other packets. The processor is configured to apply each of the plurality of binary patch packets to the binary image to generate a portion of a patched binary image and, when the processor has applied each of the plurality of binary patch packets, replace the binary image with the patched binary image.

Some embodiments of the present invention provide a non-transitory computer-readable medium including executable instructions for updating an electronic device, wherein the medium comprising instructions for: obtaining a binary patch for a binary image currently being executed by the electronic device; generating a plurality of packets based on the binary patch, wherein each packet is independent such that each packet can be applied by the electronic device to the binary image independent of applying the other packets to generate a portion of a patched binary image; and streaming each of the plurality of packets to the electronic device over at least one network.

Other aspects of the invention will become apparent by consideration of the detailed description and accompanying drawings.

### BRIEF DESCRIPTION OF THE DRAWINGS

FIG. 1 illustrates a system for updating an electronic device.

FIG. 2 illustrates a server included in the system of FIG. 1.

FIG. 3 illustrates the electronic device included in the system of FIG. 1.

FIG. 4 illustrates a method of performing binary patching.

FIGS. 5 and 6 illustrate a method of performing streaming packetized binary patching.

FIG. 7 illustrates a method of performing patch generation.

FIG. 8 illustrates a method of performing patch application.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments of the invention may include hardware, software (including firmware) and electronic components or modules that, for purposes of discussion, may be illustrated and described as if some, a majority, or all of the components were implemented solely in hardware. However, one of ordinary skill in the art, and based on a reading of this detailed description, would recognize that, in at least one embodiment, electronic based aspects of the invention may be implemented in software (e.g., stored on non-transitory computer-readable medium). As such, it should be noted that a plurality of hardware and software based devices, as well as a plurality of different structural components, may be utilized to implement the invention. Also, although reference is made herein to software being executed or adapted for execution, it will be appreciated that the present invention applies equally to firmware and firmware updates.

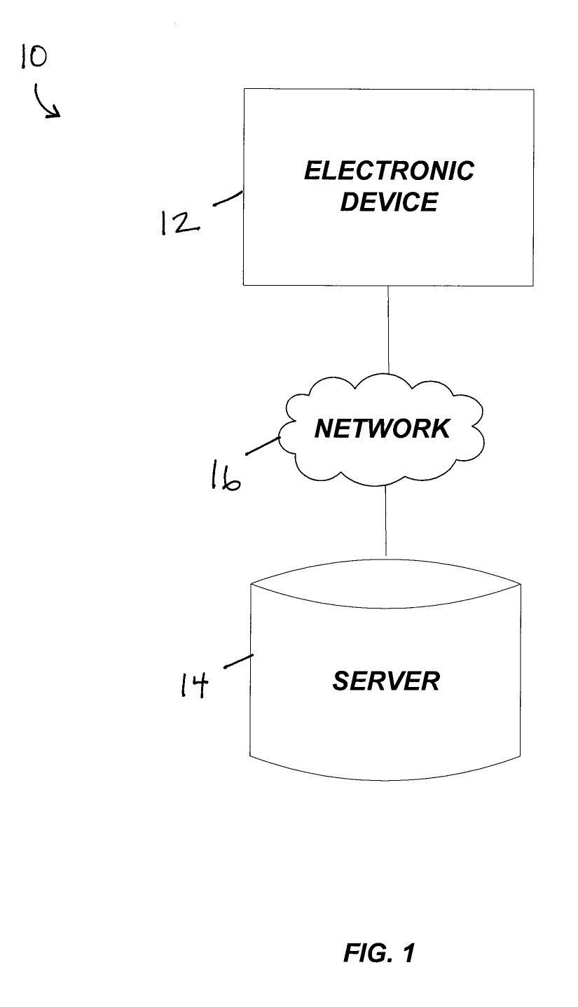

FIG. 1 illustrates a system 10 for updating an electronic device. The system 10 includes an electronic device 12 and a server 14 connected over at least one network 16. It should be understood that although only a single server 14 and a single device 12 are illustrated in FIG. 1, additional devices and systems can also be connected to the network 16 and/or directly to the server 14 and/or the device 12. For example, in some embodiments, the server 14 can be configured to manage multiple electronic devices 12 and multiple electronic devices 12 can be connected to the server 14 through the network 16. Also, in some embodiments, rather than communicating directly with the server 14, the device 12 may receive updates initiated by the server 14 through other electronic devices included in the system. For example, electronic devices can be configured to forward received updates to other similar devices. Therefore, the electronic device 12 may receive updates from the server 14 through another electronic device connected to the network 16.

The network 16 can include a local area network (“LAN”), a wide area network (“WAN”), the Internet, other geographic or proprietary networks, or any combination thereof. Also, the network 16 can be constructed from wired connections (e.g., telephone connections, cable connections, fiber optic connections, etc.), wireless connections, or any combination thereof.

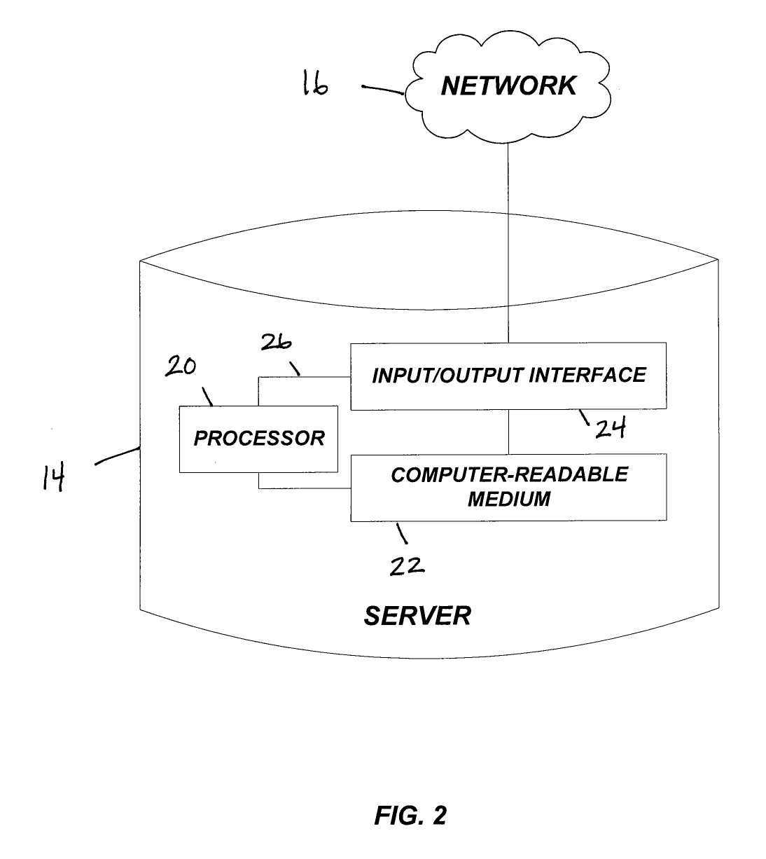

FIG. 2 illustrates the server 14 in more detail. It should be understood that FIG. 2 illustrates only one example of components included in the server 14, and that other configurations are possible. As shown in FIG. 2, the server 14 includes a processor 20, computer-readable medium 22, and an input/output interface 24. The processor 20, computer-readable medium 22, and input/output interface 24 are connected by one or more connections 26, such as a system bus. It should be understood that although the processor 20, computer-readable medium 22, and input/output interface 24 are illustrated as being included in a single server 14, these components can be distributed and combined in various combinations across multiple devices (e.g., multiple servers). Similarly, the sever 14 can include multiple processors 20, additional computer-readable medium modules 22, multiple input/output interfaces 24, and/or other additional components or modules (e.g., hardware, software, firmware, or a combination thereof).

The processor 20 retrieves and executes instructions stored in the computer-readable medium 22. The processor 20 can also store and retrieve data to and from the computer-readable medium 22. The computer-readable medium 22 can include non-transitory computer readable medium and can include volatile memory, non-volatile memory, or a combination thereof. In some embodiments, the computer-readable medium 22 includes a disk drive or other types of large capacity storage mechanism. The computer-readable medium 24 can also include a database structure that stores data processed or otherwise obtained by the server 14.

The input/output interface 24 receives information from outside the server 14 and outputs information outside the server 14. For example, the input/output interface 28 can include a network card or adapter, such as an Ethernet card or a wireless network card that allows the server 14 to send and receive information over the network 16.

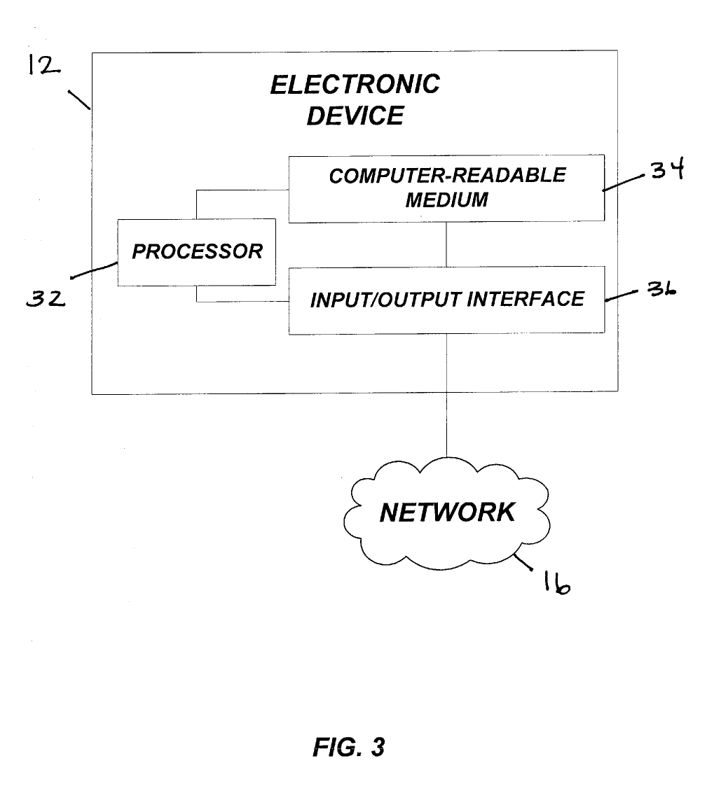

FIG. 3 illustrates the electronic device 12 in more detail. It should be understood that FIG. 3 illustrates only one example of components included in the device 12, and that other configurations are possible. As shown in FIG. 3, the device 12 includes a processor 32, computer-readable medium 34, and an input/output interface 36. The processor 32, computer-readable medium 34, and input/output interface 36 are connected by one or more connections 38, such as a system bus. It should be understood that the electronic device 12 can include multiple processors 22, additional computer-readable medium modules 34, and input/output interfaces 36 and can include additional components.

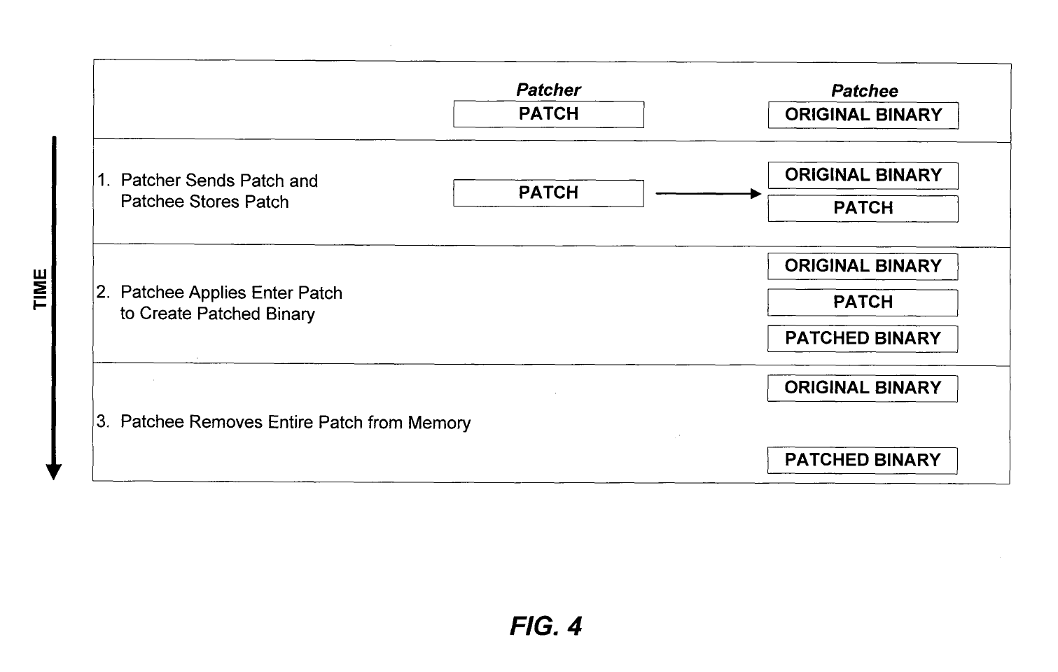

The processor 32 retrieves and executes instructions stored in the computer-readable medium 34. As described below with respect to FIG. 4, in some embodiments, the instructions include a method of performing streaming packetized binary patching. The processor 32 can also store and retrieve data to and from the computer-readable medium 34. The computer-readable medium 34 can include non-transitory computer readable medium and can include volatile memory, non-volatile memory, or any combination thereof. In some embodiments, the computer-readable medium 34 includes a disk drive or other types of large capacity storage mechanism.

The input/output interface 36 receives information from outside the device 12 and outputs information outside the device 12. In some embodiments, the input/output interface 36 includes a network interface controller (“NIC”) that includes a network card or adapter, such as an Ethernet card or a wireless network card, that allows the device 12 to send and receive information over the network 16. The input/output interface 36 can be plugged into the system bus 38 or can be built into the device's motherboard. The input/output interface 36 can implement the electronic circuitry required for the device 12 to communicate with the network 16 using a specific physical layer (OSI layer) and data link layer standard, such as Ethernet, Wi-Fi, or Token Ring. In some embodiments, the input/output interface 36 includes a processor and computer-readable medium and is configured to perform streaming packetized binary patching. Throughout the present application, functionality may be described as being performed by the electronic device 12 through the processor 32, but it should be understood that the functionality can be performed by input/output interface 36, the processor 32, or both. Also, in some embodiments, the processor 32 is included in the input/output interface 36.

The electronic device 12 executes a compiled binary image that is stored in the computer readable medium 34. Each binary image can contain the operating system for the device 12, networking stacks, and administrative applications for performing functionality, such as binary image management and diagnostic statistics. If the device 12 includes a metering device, the binary image can also include metering applications for handling metrology data.

In some embodiments, the electronic device 12 stores two or more distinct binary images in the computer-readable medium 34 (e.g., flash memory), one of which is the image currently being executed. The other image can include an old binary image or a new binary image that the device 12 is not currently executing.

In existing systems, to upgrade (or downgrade) a device's binary image (e.g., from version A to version B), the server 14 would issue a series of commands over the network 16 to the electronic device 12 to remove all binary images except the binary image currently being executed (i.e., version A). After removing all images except for the image being executed, the device 12 would continue to execute the image already being executed, which would be the only image stored in memory. The server 14 would then issue an additional series of commands to the device 12 and would transmit a new binary image (i.e., image version B) in its entirety to the device 12 over the network 16. After this process, the device's memory would include both the image currently being executed and the new image (i.e., both version A and version B of the image). The device 12 would then be instructed (e.g., by the server 14 via rebooting) to execute the new binary image (i.e., image version B), which completes the upgrade.

Alternatively, binary patching can be used to update the device 12. As shown in FIG. 4, to perform binary patching, the server 14 (i.e., the patcher) generates a binary patch. The server 14 sends the complete binary patch to the device 12 (i.e., the patchee), and the device 12 stores the entire patch to memory. The device 12 then applies the patch to its binary image currently being executed to create an updated or patched binary image. After the patched binary image is created, the device 12 can remove the entire received patch from memory (to free up memory space) and can execute the patched image.

As identified above, there are various pitfalls and costs associated with the updating processes described above. First, sending an entire new image to a device 12 can require relatively large bandwidth resources, time, and memory allocations. Using binary patching can relieve some of these issues, as a binary patch is typically smaller than a complete new image. However, sending a complete binary patch can still impose large memory requirements on a device, as the entire binary patch must be stored until it can be applied. Furthermore, although binary images are atomic (e.g., there are logical divisions in the code for different functionality), one portion of a binary image cannot typically be updated to change one aspect of the image, such as metering functionality. Rather, the entire image must be updated when performing an update. However, from version to version, the entire binary image does not change, even though an update is applied to the entire image.

To address these issues, embodiments of the present invention use streaming packetized binary patching to perform device updates. Using this updating process, individual binary patch packets are generated and transmitted to the device 12 (i.e., the input/output interface 36), rather than transmitting a complete binary patch. The packets are generally smaller than the corresponding complete binary patch, which reduces the device resources required to perform updates.

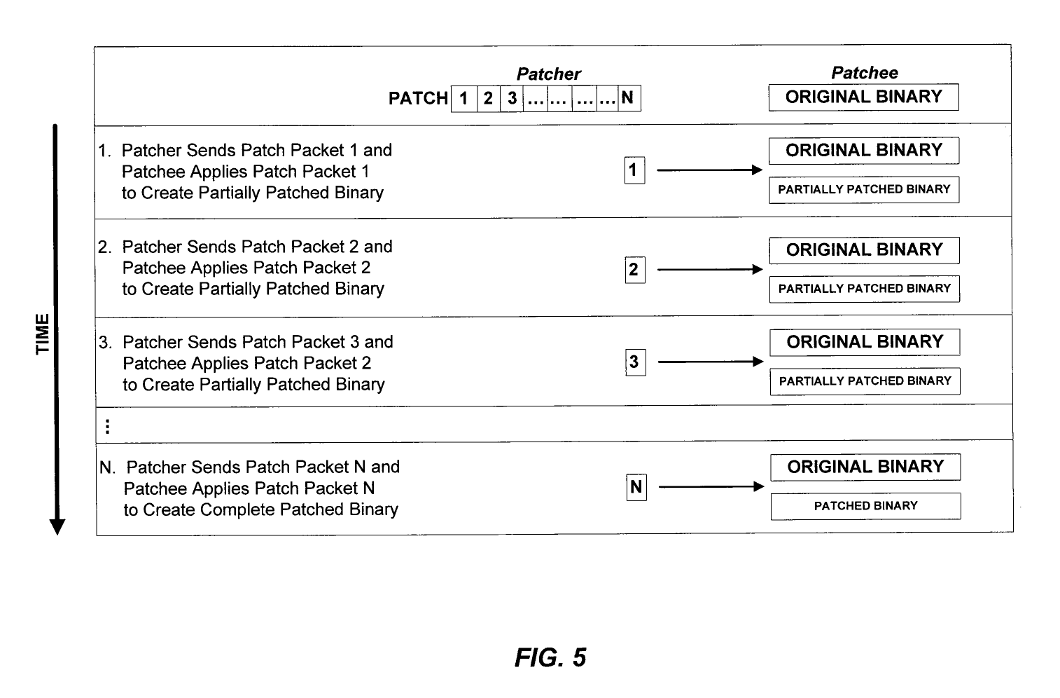

As compared to FIG. 4, FIG. 5 illustrates a method of performing streaming packetized binary patching. As shown in FIG. 5, the server 14 (i.e., the patcher) generates a patch that includes 1 to N packets, where each packet is independent and can be applied by the device 12 (i.e., the patchee) without reference to any other packets. As used herein and in the appended claims, the term “independent” means that each packet can be applied independently of the other packets of the patch. In some embodiments, each packet can also be idempotent, which means that a particular packet can be applied multiple times without changing the resulting patched binary. Also, as described in greater detail below, in some embodiments, each packet can be applied without regard to order of application of the packets of the patch.

After the patcher generates the packets, the patcher streams each packet to the patchee. Upon receiving each packet, the patchee applies the packet to the original or currently executed image to create a partially patched binary (i.e., a portion of an updated or patched binary). The patchee can then disregard the applied packet (e.g., can overwrite the applied packet with the next received packet) without storing the applied packet for any future use. The patchee continues to receive packets in this manner until all of the packets have been received and applied. After all of the packets have been applied, the patchee will have a complete patched binary image that includes the individual portions generated by each packet. The patchee can then switch to the patched binary image to complete the update.

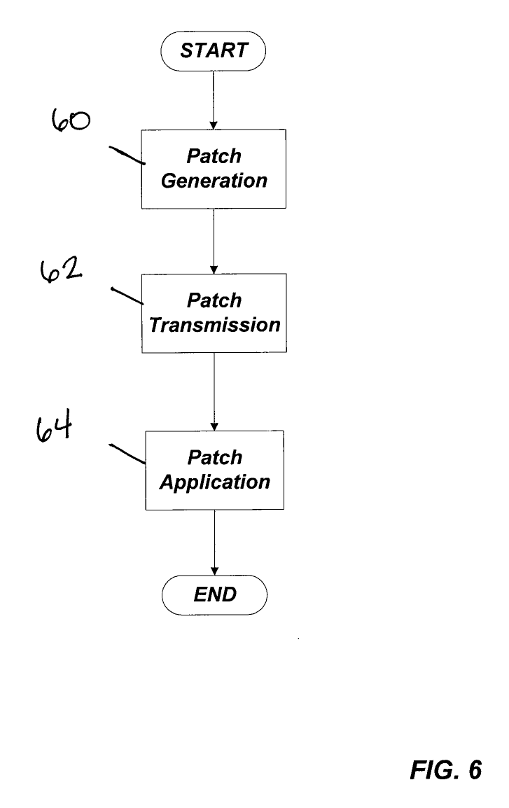

FIG. 6 illustrates a method of performing streaming packetized binary patching in more detail. As shown in FIG. 6, the method generally consists of three parts: (1) patch generation (at 60), (2) patch transmission (at 62), and (3) patch application (at 64). It should be understood that because multiple packets of a binary patch are being generated, transmitted, and applied, patch transmission and patch application can occur simultaneously and repeatedly as each packet is transmitted to the device 12 and applied.

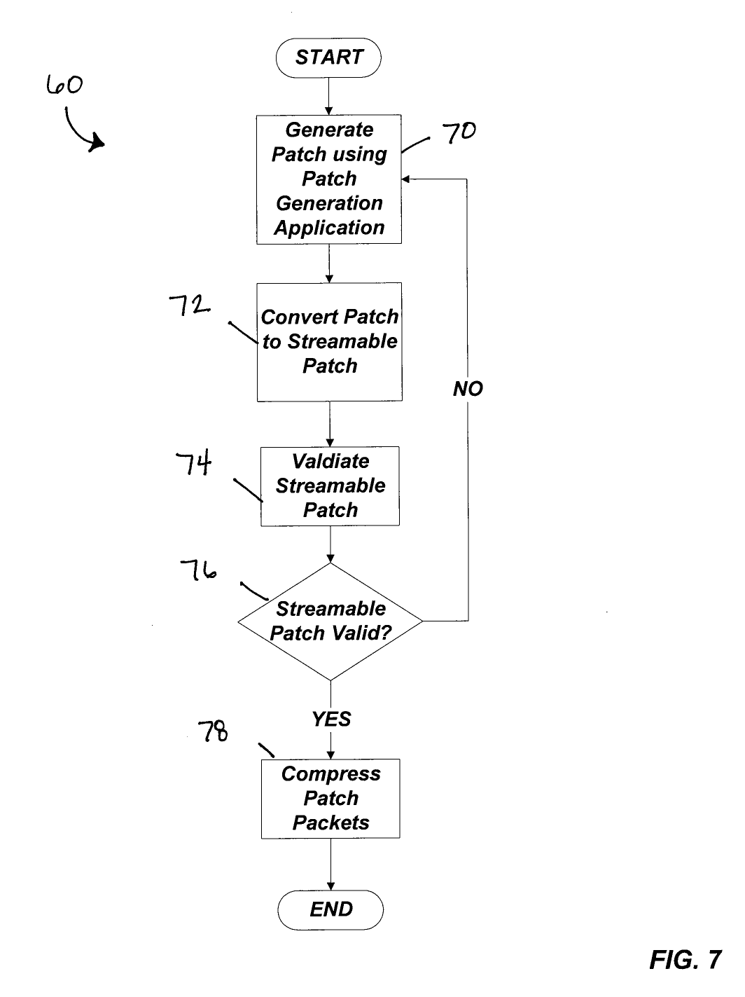

FIG. 7 illustrates patch generation (60) in more detail. As shown in FIG. 7, during patch generation, the server 14 uses one or more binary patch generation or difference applications to generate a binary patch (at 70). There are numerous patch generation applications available, such as bspatch, xdelta, and RTpatch, and each provide information about how the patch is generated, how code is complied into a binary image, and the format of the resulting patch. For example, bsdiff is a specialized binary differencing application that is optimized for generating size-wise efficient binary patches for compiled code. For example, the patches generated by bsdiff can be in general up to 58% smaller in size as compared to the image to which the patch is applied. Furthermore, in cases where the images differ very little, the patch can be approximately 96% smaller than the image. Similarly, bspatch is a utility that is distributed with bsdiff, and applies the patch to the original binary image to generate a new binary image.

The patch generated by the bsdiff application generally has three disjoint logical sections that are concurrently accessed during the patching process. Each logical section is compressed using BZ2 compression. As provided, however, bsdiff and bspatch require that the entire patch be present and stored on the target device before the patch application process occurs. In particular, after a device receives an entire patch generated by the bsdiff application, the bspatch application (or other code preprogrammed in the device 12) decompresses the patch and reads and applies each logical section found in disparate locations in the patch. Therefore, using bspatch requires that the entire patch be stored on the target device, which constrains the target device's memory. Furthermore, once the patch is uncompressed, it is even larger (e.g., sometimes even larger than the image to which it is to be applied), which creates even further memory constraints. Also, because bspatch uses BZ2 compression, the target device must include hardware, software, and/or firmware for performing BZ2 decompression. If the target device does not include this functionality, this functionality must be downloaded to the device (e.g., with the patch or separately), which creates additional download costs and memory constraints.

Therefore, returning to FIG. 7, using streaming packetized binary patching, the server 14 takes the patch generated by the patch generation application, such as bsdiff, and can parse and recast the patch using a conversion utility to convert the patch into a format suitable for packetizing and streaming (at 72). The conversion utility can be configured based on the file format of the patch generated by the patch generation application. For example, a patch generated by the bsdiff application has the following file format:

| | | |
|---|---|---|
| Offset: 0, | length: 8 | “BSDIFF40 |
| Offset: 8, | length: 8 | x |
| Offset: 16, | length: 8 | y |
| Offset: 24, | length: 8 | newfile length |
| Offset: 32, | length: x | control block - bz2'ed |
| Offset: 32 + x, | length: y | diff block - bz2'ed |
| Offset: 32 + x + y, | length: ~ | extra block - bz2'ed |

Uncompressed, the control block contains a series of 3-tuples (i, j, k) that are interpreted by the bspatch patching process in the follow manner:

i—read the next i bytes from the diff block and arithmetically add them to the next i bytes of the old image (an offset into the old image is kept throughout the bspatch patching mechanism). These summed i bytes are the next i bytes of the new image.

j—read the next j bytes from the extra block. These j bytes are the next j bytes of the new image.

k—move the offset into the old image by k bytes. No new bytes are contributed to the new image.

During the patch application process performed by bspatch, a simple state machine loops over all 3-tuples until the entire control block is consumed, at which time the patch is fully applied. The conversion utility (referred to as “Patch_gen” below) implements a similar state machine, but instead of applying the patch to the original image, it rewrites the patch in a different format. For example, for each 3-tuple encountered, the streamed patch file looks as described below.

For the i parameter of the 3-tuple, the following is inserted into the new patch:

```
struct img_mgmt_patch_op_add {
    uint16_t ipo_op;
    uint16_t ipo_len;
    uint32_t ipo_off ;
    uint8_t ipo_data[0] ; /* ipo_len worth of data */
}
```

Here, the ipo_op field is set to be IMG_MGMT_PATCH_OP_ADD. The ipo_len field, same as i, is the number of bytes after the ipo_off field. The ipo_off field is the offset into the old image file that is used. At that offset, ipo_len bytes are read from the old image, and are added to the ipo_len bytes at the ipo_data field. The resultant summation becomes the next ipo_len bytes of the new image.

For the j parameter of the 3-tuple, the following is inserted into the new patch:

```
struct img_mgmt_patch_op_extra {
    uint16_t ipo_op;
    uint16_t ipo_len;
    uint8_t ipo_data[0]; /* ipo_len worth of data */
  }
```

Here, the ipo_op field is set to be IMG_MGMT_PATCH_OP_EXTRA. The field ipo_len, same as j, is the number of bytes in the ipo_data location. The ipo_len bytes of data at ipo_len are the next bytes of the new image.

For the z parameter of the 3-tuple, nothing is introduced into the new patch. An internal state tracks where the old image file pointer is, and uses the current value when needed in the img_mgmt_patch_op_add structure.

In addition, since the patch is packetized and streamed, packet size (compressed and uncompressed alike) is taken into account as the struct img_mgmt_patch_op blocks are written to the new file. One value of i or j could be so large that it would exceed a maximum packet length constraint. In such cases, a series of struct img_mgmt_patch_op structures are written to the new patch such that the overall patch can be packetized into acceptable lengths. Therefore, the complete file format of the streamable patch is as follows:

```
uchar magic[8] = “SSNDIFF0”;
uint32_t packet_count;
/* following is a ‘packet_count’ worth of packets */
/* a packet starts with the length followed by that number of bytes of
data*/
    uint32_t length; /* # of uncompressed bytes in the next packet */
    struct img_op_cmd;
    struct img_op_patch_req;
    /* followed by one or more of any combination of */
    struct img_mgmt_patch_op_add;
    struct img_mgmt_patch_op_extra;
```

After this process, the packet is ready to be sent with the exception of a packet header and any compression applied to the payload. Because the computation of the compressed packet boundaries can continue for a few minutes, the packet boundaries of the patch can be computed and serialized in advance.

As shown in FIG. 7, in some embodiments, after a streamable patch is generated, the server 14 can test the patch to ensure that it is valid and correct (at 74). In particular, to validate the patch, the server 14 can apply the streamable patch packets to the old or original binary image to create a patched image. The server 14 can then compute a checksum for the patched image, and can compare the checksum to a checksum associated with the intended new binary image. If the checksums are the same (at 76), the server 14 concludes that the patched binary is the same as the intended new binary image, and the streamable patch is valid. If the checksums are not the same (at 76), the server 14 can repeat one or more steps of the patch generation method 60 until a valid streamable patch is generated.

In some embodiments, the server 14 also compresses the patch packets to decrease patch packet size (at 78 in FIG. 7). Different compression algorithms can be used. In particular, because the patch generated by the patch generation application has been recast, the server 14 can use a compression algorithm different than the compression algorithm used by the patch generation application. For example, the server 14 can use a compression algorithm that the electronic device 12 is preprogrammed to perform for the necessary decompression (e.g., LZ77 compression). Using a compression algorithm that the electronic device 12 is familiar with eliminates the need for the server 14 to transmit additional applications or libraries to the device 12, which otherwise causes additional bandwidth, time, and memory constraints.

Returning to FIG. 6, after the streamable patch is generated including the individual packets, the server 14 streams the individual packets to the input/output interface 36 of the electronic device 12 (e.g., using a network management protocol) (at 62). As described above, each patch packet can include an atomic piece of the overall patching story. In addition, in some embodiments, each packet is independent and/or idempotent. Therefore, each packet can be applied without reference to the other packets of the patch, and/or can be applied multiple times (e.g., for redundancy purposes) without affecting the resulting updated or patched binary image. Also, in some embodiments the packets can be applied in any order. Accordingly, in various embodiments, the server 14 can send the packets to the input/output interface 36 in a sequential order or in a non-sequential order). As described in more detail below, the input/output interface 36 and/or the processor 32 can use various accounting processes to keep track of what packets have been received and applied and what packets are still needed. However, to simplify accounting, a sequential (e.g., ascending) ordering can also be used, where the server 14 transmits packets to the input/output interface 36 in a sequential order.

Returning to FIG. 6, the input/output interface 36 receives the patch packets and the processor 32 applies the packets through a series of operations to the original binary to generate a new or updated binary image (at 64). After the processor 32 has applied all of the patch packets, the device 12 has a complete patched binary image, which can be set as the new binary image (e.g., replace the existing binary image currently being executed by the device 12), such as on the next reboot.

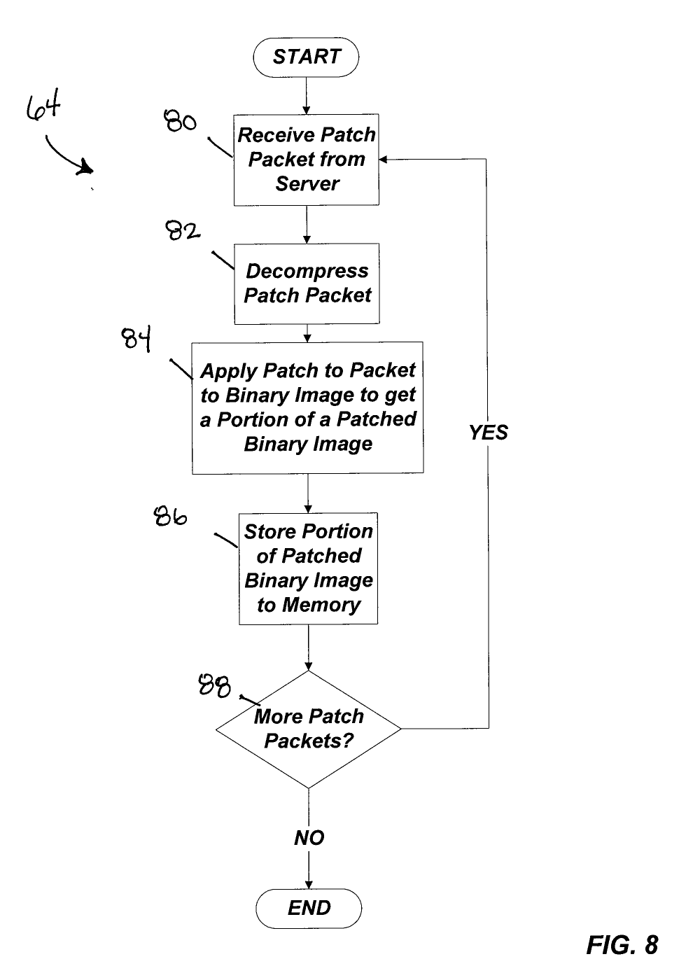

FIG. 8 illustrates the patch application process (64) in more detail. As illustrated in FIG. 8, the input/output interface 36 of the device 12 receives a patch packet from the server 14 (at 80). The input/output interface 36 and/or the processor 32 decompresses the patch packet and stores the decompressed packet to a buffer (at 82). The buffer can be included in the computer-readable medium 34 and can be allocated on a heap at the time the input/output interface 36 and/or the processor 32 receives the first patch packet. The buffer is used to expand the patch packet into the next segment of the new image. In some embodiments by way of example only, the buffer is approximately 65536 bytes. The buffer can remain allocated until the next reboot of the device 12 (e.g., the reboot performed to switch the device to the new binary image after all patch packets have been received and applied). Next, the processor 32 applies the packet to the binary image currently being executed to create a portion of a patched binary image (at 84). After the portion of the patched binary is created, the portion can be stored to memory (e.g., the computer-readable medium 34) (at 86).

After the packet has been applied (and the resulting portion of the patched binary image has been stored to memory), the packet can be discarded, and does not need to be stored in the device's memory for any future use. Accordingly, the packet can be erased from the buffer, or the input/output interface 36 may simply overwrite the packet with the next packet received from the server 14.

As shown in FIG. 8, the input/output interface 36 and/or the processor 32 can then determine whether there are more packets yet to receive (at 88). In some embodiments, the server 14 can send the packets sequentially, and can include an end marker or other indicator in the last packet that informs the input/output interface 36 and the processor 32 that all packets have been received. In some embodiments, after the server 14 transmits all of the packets, the server 14 can transmit information to the input/output interface 36 signaling that all packets have been sent. In these and other embodiments, the server 14 can send the input/output interface 36 initial information about the stream of packets (e.g., in the first packet) indicating a number of packets, packet size(s), packet order, etc. to be received The input/output interface 36 and/or the processor 32 can use this information to track what packets have been received. For example, if the server 14 informs the input/output interface 36 that 7 packets will be sent in random order numbered 0 through 6, the interface 36 and/or the processor 32 can keep track of what packet numbers have been received, and may disregard any duplicate packets. Once the interface 36 and/or the processor 32 identifies that all 7 packets have been received and applied, the interface 36 can signal the server 14 that all packets have been received, and can await further instructions from the server 14 (e.g., a reboot command). Alternatively, the device 12 can be configured to automatically perform a reboot after the input/output interface 36 and/or the processor 32 determines that all packets have been received and successfully applied.

As described above, using streaming packetized binary patching can reduce resources needed for performing a device update. For example, the device 12 only needs to store a packet as it is being applied, and then can disregard the packet. Therefore, the memory requirements on the device 12 are lessened. Furthermore, using streaming packetized binary patching can decrease the time required to perform a device upgrade (or downgrade). For example, when a complete binary patch is download or transmitted to the target device, network loss or unavailability may require the entire patch download or transmission to be restarted. However, if individual patch packets are streamed to the device, network loss or unavailability may only require individual packets to be retransmitted, rather than retransmitting the entire patch.

It should be understood that the computer code included in this application is provided as an example of what the code and data structures may look like for performing streaming packetized binary patching. Other code formats, structures, and languages and other variable names and data structures may be used to perform packetized binary patching as described in the present application.

Various features and advantages of the invention are set forth in the following claims.

What is claimed is:

1. A computer-implemented method for updating an electronic device, the method comprising:
obtaining a binary patch for a binary image currently being executed by the electronic device;
generating a plurality of packets based on the binary patch, wherein each packet is independent such that each packet can be applied by the electronic device to the binary image independent of applying the other packets to generate a portion of a patched binary image; and
streaming each of the plurality of packets to the electronic device over at least one network.

2. The method of claim 1, wherein obtaining a binary patch includes executing a patch generation application.

3. The method of claim 2, wherein executing a patch generation application includes creating a patch based on the differences between the first binary image and a second binary image.

4. The method of claim 1, wherein generating a plurality of packets includes generating a plurality of packets in which each of the plurality of packets is idempotent.

5. The method of claim 1, wherein streaming each of the plurality of packets includes streaming each of the plurality of packets in a non-sequential order with respect to generation of the plurality of packets.

6. The method of claim 1, further comprising applying the plurality of packets to the binary image currently being executed by the electronic device in a non-sequential order with respect to generation of the plurality of packets.

7. The method of claim 1, further comprising validating the plurality of packets.

8. The method of claim 7, wherein validating the plurality of packets includes applying the plurality of packets to the binary image to create a patched binary image, generating a first checksum for the patched binary image, and comparing the first checksum to a second checksum of a second binary image, the second binary image including an updated version of the first binary image.

9. A system for updating an electronic device, the system comprising:
a server configured to obtain a binary patch for a binary image currently being executed by the electronic device, to generate a plurality of packets based on the binary patch, wherein each packet is independent such that each packet can be applied by the electronic device to generate a portion of a patched binary image independent of applying the other packets, and to stream each of the plurality of packets to the electronic device over at least one network.

10. The system of claim 9, further comprising an electronic device configured to receive each of the plurality of packets from the server, apply each of the plurality of packets to the binary image to generate a portion of a patched binary image, and, when the electronic device has received each of the plurality of packets, replace the binary image with the patched binary image.

11. The system of claim 9, wherein the server is configured to obtain a binary patch by executing a patch generation application.

12. The system of claim 11, wherein the server is configured to execute a patch generation application to create a patch based on the differences between the first binary image and a second binary image.

13. The system of claim 9, wherein each of the plurality of packets is idempotent.

14. The system of claim 9, wherein the server is configured to stream each of the plurality of packets in a non-sequential order with respect to generation of the plurality of packets.

15. The system of claim 9, wherein the electronic device is configured to apply each of the plurality of packets in a non-sequential order with respect to generation of the plurality of packets.

16. The system of claim 9, wherein the server is further configured to validate the plurality of packets.

17. The system of claim 16, wherein the server is configured to validate the plurality of packets by applying the plurality of packets to the binary image to create a patched binary image, generating a first checksum for the patched binary image, and comparing the first checksum to a second checksum of a second binary image, the second binary image including an updated version of the first binary image.

18. An electronic device configured to execute a binary image, the device comprising:
a processor; and
an input/output interface configured to receive a stream of a plurality of binary patch packets from at least one server, each of the plurality of binary patch packets being generated by the server based on a binary patch and being independent such that each packet can be applied by the electronic device to the binary image independent of the other packets,
the processor configured to apply each of the plurality of binary patch packets to the binary image to generate a portion of a patched binary image and, when the processor has applied each of the plurality of binary patch packets, replace the binary image with the patched binary image.

19. The device of claim 18, wherein the electronic device includes computer-readable medium and the processor is configured to store each portion of the patched binary image to the computer-readable medium.

20. The device of claim 19, wherein the processor is configured to disregard each of the plurality of binary patch packets without storing each of the binary patch packets to the computer-readable medium after applying each of the plurality of binary patch packets to the binary image.

21. The device of claim 18, wherein each of the plurality of binary patch packets is idempotent.

21. The device of claim 18, wherein the input/output interface is configured to receive each of the plurality of binary patch packets in a non-sequential order with respect to an order in which the plurality of packets were generated.

22. The device of claim 18, wherein the processor is configured to apply each of the plurality of binary patch packets in a non-sequential order with respect to an order in which the plurality of packets were generated.

23. The device of claim 22, wherein the processor is configured to track which of the plurality of binary patch packets have been received and when all of the plurality of binary patch packets have been received.

24. Non-transitory computer-readable medium including executable instructions for updating an electronic device, the medium comprising instructions for:
obtaining a binary patch for a binary image currently being executed by the electronic device;
generating a plurality of packets based on the binary patch, wherein each packet is independent such that each packet can be applied by the electronic device to the binary image independent of applying the other packets to generate a portion of a patched binary image; and
streaming each of the plurality of packets to the electronic device over at least one network.

25. The computer-readable medium of claim 24, wherein the instructions for obtaining a binary patch include instructions for executing a patch generation application.

26. The computer-readable medium of claim 25, wherein the instructions for executing a patch generation application include instructions for creating a patch based on the differences between the first binary image and a second binary image.

27. The computer-readable medium of claim 24, wherein the instructions for generating a plurality of packets include instructions for generating a plurality of idempotent packets.

28. The computer-readable medium of claim 24, wherein the instructions for streaming each of the plurality of packets include instructions for streaming each of the plurality of packets in a non-sequential order with respect to generation of the plurality of packets.

29. The computer-readable medium of claim 24, wherein the instructions for streaming each of the plurality of packets include instructions for streaming each of the plurality of packets in a non-sequential order with respect to generation of the plurality of packets.

30. The computer-readable medium of claim 24, further comprising instructions for validating the plurality of packets.

31. The computer-readable medium of claim 30, wherein the instructions for validating the plurality of packets include instructions for applying the plurality of packets to the binary image to create a patched binary image, generating a first checksum for the patched binary image, and comparing the first checksum to a second checksum of a second binary image, the second binary image including an updated version of the first binary image.
